(19) United States
(12) Patent Application Publication
(10) Pub. No.: US 2005/0279741 A1
(43) Pub. Date: Dec. 22, 2005

(54) Laser burn through sensor

(76) Inventors: Jonathan W. Arenberg, Santa Monica, CA (US); Allen S. Sun, Culver City, CA (US); Hiroshi Komine, Torrance, CA (US); Matthew W. Soule, Hermosa Beach, CA (US)

Correspondence Address: COBRIN & GITTES, 750 LEXINGTON AVENUE, 21ST FLOOR, NEW YORK, NY, 10022, US

(21) Appl. No.: 10/872,028

(22) Filed: Jun. 17, 2004

(51) Int. Cl. B23K 26/00

(52) U.S. Cl. 219/121.83

(57) ABSTRACT

An optical sensor for detecting the presence of laser radiation in locations outside an intended optical path in a high energy laser device. An optical sensor, such as a photodiode, is positioned to receive light through an optical component when it fails to operate properly and laser light burns through the component. The optical sensor preferably includes a diffuser, an optical filter, and electrical circuitry to compare the signal generated by the photodiode with a selected reference signal, and to use the photodiode signal to actuate an alarm indicator and to disable power to the laser source. A thermal detector may be employed as a backup detection device.

This invention was made with Government support under Contract No. F29601-03-C-0061 awarded by the U.S. Air Force. The Government has certain rights in this invention.

### BACKGROUND OF THE INVENTION

This invention relates generally to optical systems for high energy lasers and, more particularly, to protective devices for sensing any unwanted deviation of laser radiation from its intended optical path. High energy lasers have many commercial and military applications. Commercial uses include welding and cutting operations. Military uses include missile defense, including directed energy systems based either at fixed locations on the ground or in moving vehicles on or above ground. All such applications have in common the need to confine a high energy laser beam to a designated optical path, using mirrors or other optical components. There is always some level of risk that optical components exposed to high levels of radiation will break down, allowing laser radiation to “burn through” a component, and then inflict damage on anything along an unwanted optical path. Without early detection of laser burn through, there is a significant risk of damage to property, as well as serious, and possibly fatal, injury to nearby personnel.

Prior to the present invention, detection of laser burn through, or mirror failure, in high energy laser systems has been accomplished by means of thermally actuated devices of some kind. For example, U.S. Pat. No. 5,991,319 issued in the names of Zamel et al. and entitled “Mirror Failure Detector for High Power Lasers,” teaches the use of a thermal sensor installed behind a mirror surface to detect any significant increase in temperature, which would occur if laser radiation were to break through the mirror surface. The thermal sensor, when actuated, would shut off power to the laser and trigger an alarm indication. Unfortunately, thermal sensors of this and similar types have a relatively slow response time. In the sensor disclosed in the Zamel et al. patent, for example, radiation penetrating the mirror must raise the temperature of the sensor to its preset triggering level before detection occurs. Thermal detection inherently involves a delay during which the radiation being detected raises the temperature of the detector and its surrounding structure. The Zamel et al. patent teaches various ways of minimizing this inherent thermal delay, by controlling the sensor temperature during normal operation, but thermal sensors nevertheless have limited reaction times measured in seconds. Unfortunately, a high energy laser beam can do an enormous amount of damage in a very short time.

Another inherent drawback to the use of thermal detectors is that they may, in some environments, be subject to false positive alarm indications. In the environment of space, for example, solar heating may raise the temperature of a thermal sensor sufficiently to shut off the laser beam or a cold bias may not indicate a dangerous condition. In an industrial environment, heat from other nearby sources may have a similar effect. Even if the effects of other sources of heat can be controlled or isolated, doing so results in increased design complexity for the protective device.

Accordingly, it will be appreciated that there is still a significant need for a sensor that can detect laser burn through much more rapidly than thermal devices and will not be sensitive to heating from other sources of radiation. The present invention satisfies this need.

### SUMMARY OF THE INVENTION

The present invention resides in use of an optical sensor for sensing laser burn through of a component in an optical path carrying radiation from a high energy laser source. Briefly, and in general terms, the optical laser burn though sensor of the invention comprises an optical detector located to receive laser light whenever laser burn through occurs; and circuitry coupled to the optical detector, to produce an alarm indication of a burn through condition and to produce a signal usable to disable the high energy laser source.

Preferably, the optical laser burn through sensor further comprises a light diffuser, positioned near the optical detector to reduce the need for alignment of the optical detector with laser light from the high energy source; and an optical filter, positioned to receive light entering the optical detector, to ensure that only light from the high energy laser source affects the optical detector.

More specifically, the circuitry coupled to the optical detector comprises an amplifier, to amplify an electrical signal output from the optical detector; a comparator, to compare the output from the optical detector with a selected threshold level; and a latch to retain an alarm condition as soon as the output from the optical detector exceeds the threshold level. The circuitry also comprises an alarm indicator coupled to the latch to provide an indication of an alarm condition. As disclosed by way of example, the alarm indicator may include a photodiode.

The optical laser burn through sensor also preferably comprises means for disabling operation of the high energy laser source when the alarm indicator is activated. The means for disabling operation of the high energy laser source may comprise a relay to disconnect power from the high energy laser source. In a disclosed embodiment of the optical laser burn through sensor, the circuitry coupled to the optical detector further comprises an adjustable reference signal supplying the threshold level.

In accordance with one aspect of the invention, the sensor of the invention further comprises a thermal detector located to sense any increase in temperature adjacent to the optical detector; and circuitry coupled to the thermal detector, to produce a backup alarm indication of a burn through condition and to produce a secondary signal that is also usable to disable the high energy laser source. The sensor further comprises means for logically combining the signal generated by the circuitry coupled to the optical detector and the secondary signal generated by the circuitry coupled to the thermal detector, to produce a composite signal for disabling the high energy laser source.

In accordance with another aspect of the invention, multiple optical sensors may be combined to protect multiple optical components in one apparatus. For example, the invention may be defined as apparatus for sensing laser burn through in any of a plurality of optical components receiving energy from a high energy laser source, the apparatus comprising a plurality of optical laser burn though sensors, each comprising an optical detector located to receive laser light whenever laser burn through occurs; and circuitry coupled to the optical detector, to produce an alarm indication of a burn through condition; and means for logically combining the alarm indications of a burn through condition, to provide a high energy laser disabling signal whenever at least one of the plurality of optical laser burn through sensors produces an alarm indication.

It will be appreciated from the foregoing summary, that the invention provides a significant advance in the field of high energy laser systems. In particular, the invention senses laser burn through in optical components, using an optical sensor rather than a thermal detector, and thereby provides a more rapid detection of laser burn through, so that the high energy laser source can be disabled before any significant damage is done by the laser burn through. Other aspects and advantages of the invention will become apparent from the following more detailed description, taken in conjunction with the accompanying drawings.

### BRIEF DESCRIPTION OF THE DRAWINGS

FIG. 1 is a simplified schematic diagram of the burn through sensor of the present invention.

FIG. 2 is a simplified circuit diagram depicting the electronics associated with the sensor of the invention.

FIG. 3, is an elevation view a mechanical assembly in which the sensor of the present invention is installed.

FIG. 4 is a schematic diagram showing connection of multiple sensors of the invention connected together to protect optical apparatus at multiple locations.

### DETAILED DESCRIPTION OF THE INVENTION

As shown in the drawings for purposes of illustration, the present invention pertains to a protective device for sensing laser burn through of an optical component. As discussed above, high energy laser equipment poses a serious risk of damage to equipment and personnel unless means are provided for sensing any deviation of laser radiation from its intended optical path. Thermal sensors of the prior art are inherently slow to react to laser burn through and may also be sensitive to heat radiated from other sources.

In accordance with the invention, one or more optical detectors are employed to detect the presence of laser radiation in locations where there should be none. Use of an optical detector significantly reduces the reaction time of the sensor, relative to one of the thermal type, and therefore significantly reduces the risk of damage from an errant laser beam that has burned through an optical component.

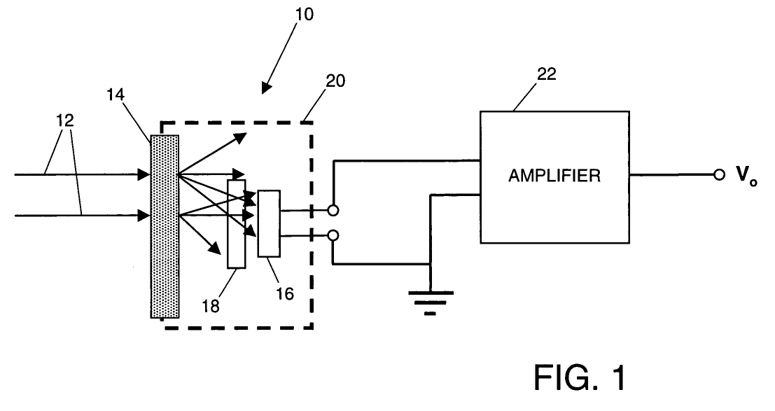

FIG. 1 illustrates the principle of the present invention. An optical sensor, indicated generally by reference numeral 10, is positioned to receive laser light 12 that has burned through an optical component such as a mirror (not shown). The sensor 10 comprises a diffuser 14 through which the incident light 12 is passed, and a photodiode 16 positioned to receive diffused light from the diffuser. The diffuser 14 obviates the need for precisely aligning the photodiode 16 with the incident light 12. Preferably, the sensor 10 also includes an optical filter 18 positioned in the path of light impinging on the photodiode 16. Depending on the specific application of the sensor 10 and the wavelength of the laser radiation, the filter 18 may be a narrow bandpass filter or, in an appropriate case, a highpass or lowpass filter. The purpose of the filter 18 is to ensure that only the incident laser light 12 is passed to the photodiode 16.

The sensor 10 may be partially or completely enclosed in a housing, indicated by the broken line 20. Electrical output from the photodiode 16 is coupled to amplifier circuitry, indicated by block 22.

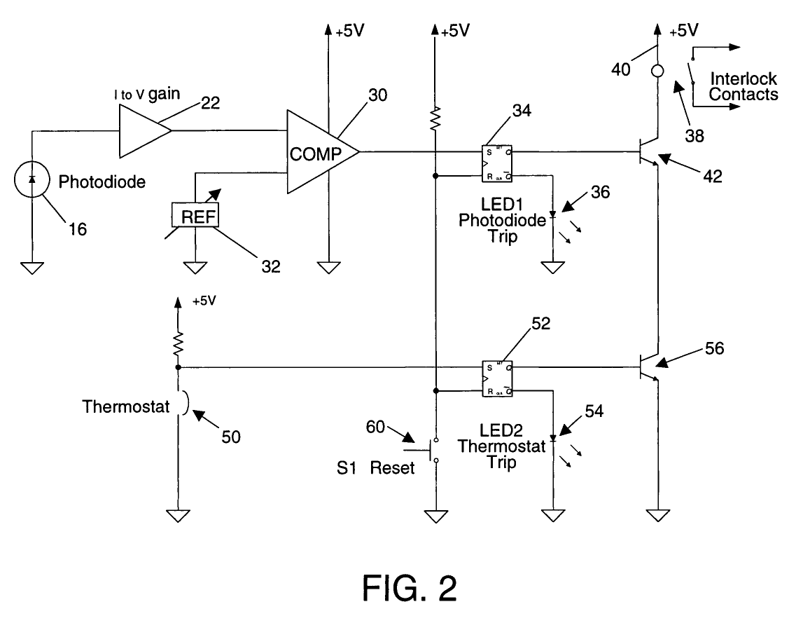

FIG. 2 is a simplified schematic diagram showing the photodiode 16 in relation to its associated circuitry. The output of the photodiode 16 is amplified by the amplifier 22, the output of which is coupled to one input of a comparator 30. The other input to the comparator 30 is derived from a variable reference signal 32. The comparator 30 acts as a discriminator circuit, producing an output signal only when the amplified output of the photodiode 16 exceeds a selected reference level. The output from the comparator 30 is coupled to a latch 34. Thus, when there is a sufficiently high output from the photodiode 16, the latch 34 is set and this has two immediate effects. First, a photodiode trip indicator, which may take the form of a light-emitting diode 36, is actuated and, second, an interlock relay 38 has its contacts opened, to deactivate the laser source (not shown) in which the detected laser radiation was generated. By way of example, the interlock relay 38 is shown as receiving power through a power circuit 40, which may be interrupted by a transistor switch 42 when the latch 34 is set by detection of light at the photodiode 16.

Preferably, the protective device of the invention also comprises a thermostat 50, which is actuated when a preselected temperature is detected, resulting in a “set” signal being applied to a second latch 52. If this second latch 52 is set, a thermostat trip indicator, such as light-emitting diode 54, is actuated, and the interlock relay power circuit 40 is interrupted by a second transistor switch 56, which is connected in series with the first transistor switch 42. This series connection of the two transistor switches 42 and 56 results in a logical OR-ing of the photodiode trip signal and the thermostat trip signal. That is to say, either detection of sufficient optical energy by the photodiode 16 or detection of a selected elevated temperature by the thermostat 50, will result in actuation of the interlock relay 38 and consequent disablement of the laser source. It will be understood, however, that the trip signals derived from the photodiode 16 and the thermostat 50 may be logically combined in some other way to meet the specific needs of an application of the invention.

As further shown in the simplified schematic diagram of FIG. 2, a manual reset switch 60 is also provided, to apply a reset signal to the latches 34 and 52. Applying the reset signal also extinguishes the light-emitting diodes 36 and 54 and closes the interlock relay 38 again.

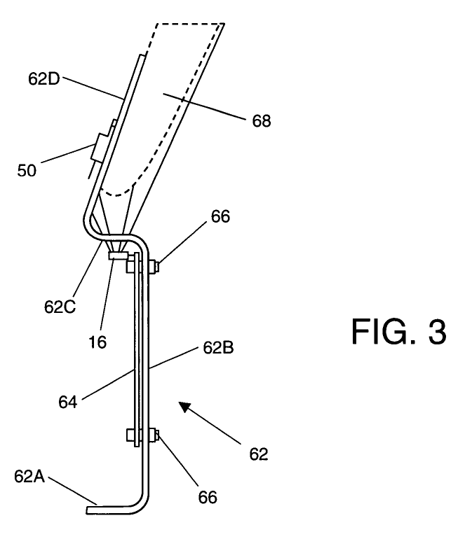

FIG. 3 depicts the assembled components of the sensor device as configured for a specific application. To meet mechanical constraints imposed by the application, the components are mounted on a single-piece mounting plate 62. The mounting plate 62 is formed as a flat, rectangular plate of uniform thickness, and then bent to form four contiguous segments 62A, 62B, 62C and 62D. Segments 62A, 62B and 62C form a generally U-shaped structure, with the middle segment of these, 62B, providing a flat surface on which a circuit board 64 is mounted, using mounting hardware indicated at 66. The fourth segment 62D is bent to form an angle less than ninety degrees with respect to the contiguous segment 62C. This angled segment 62D performs the function of the diffuser 14 introduced in FIG. 1 and maybe a rough surface, diffuser glass, ceramic or packed powder, anything that provides a diffuse reflection. Light impinging on the angled surface 62D is diffusely reflected through an aperture in segment 62C of the mounting plate and impinges on the photodiode 16, which is mounted on the other side of the aperture and is coupled to the circuit board 64. The thermostat 50 is mounted on the back side of the segment 62D and coupled by external wiring to the circuit board 64. The filter 18 (not shown in FIG. 3) is positioned in or near the aperture in segment 62C of the mounting plate. The region indicated at 68 depicts the field of view of the sensor. Not shown in the assembly of FIG. 3 are the relay 38, which is mounted on the circuit board 64, and an input/output connector, also mounted on the circuit board.

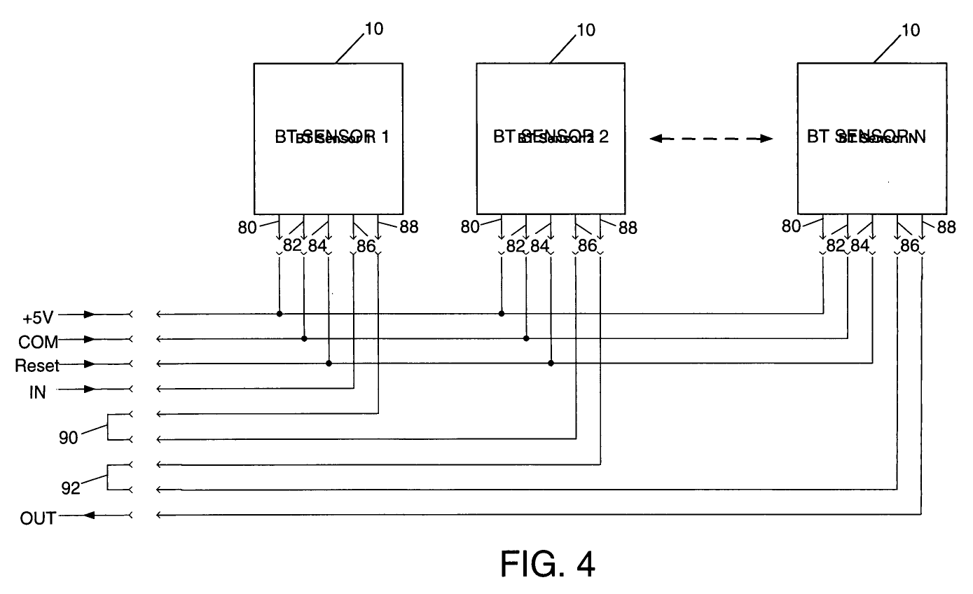

FIG. 4 shows by way of example how multiple sensors 10 may be connected in a serial string. Each sensor 10 has a pair of power supply terminals 80 and 82, for input of power, a reset terminal 84 for applying a reset signal to the sensor, and a pair of relay contact terminals 86 and 88. Externally, the relay contact terminals of the sensors 10 are connected in series, as indicated by the looping connections 90 and 92, for example. Thus, the interlock relay contacts of the sensors 10 are connected in a single series string terminated by the lines designated as IN and OUT. If any one or more sensors detects a burn through condition, either optically or thermally, at least one of the interlock relays 38 in the sensors will be opened and power will be disconnected from the laser source.

Although the total response time from detection of burn through until disconnection of power may take a few milliseconds because of the speed of operation of electromechanical relays, the detector response time for the photodiode 16 is drastically reduced in comparison with thermal detectors. Photodiodes have a response time measured in nanoseconds which is much faster than characteristic thermal time scales. Moreover, a photodiode can be configured to provide a very sharply defined threshold of operation, in terms of power density (watts per cm²). Below the threshold, no detector signal is generated, but as soon as the power density threshold is exceeded, a laser disabling signal is generated. Thermal detectors of the prior art were characterized by a broad “gray” area at the threshold, in which it was impossible to predict whether or not burn through had occurred.

It will be appreciated from the foregoing that the present invention represents a significant advance in the field of high energy lasers. In particular, the invention provides a more rapidly responsive laser radiation detector, to provide an immediate indication of the occurrence of laser burn through, thereby reducing the risk of damage to equipment and injury to personnel. It will also be appreciated that, although a specific embodiment of the invention has been illustrated and described by way of example, various modifications may be made without departing from the spirit and scope of the invention. Accordingly, the invention should not be limited except as by the appended claims.

1. For use in a high energy laser source, an optical laser burn though sensor, comprising:
an optical detector located to receive laser light whenever laser burn through occurs; and
circuitry coupled to the optical detector, to produce an alarm indication of a burn through condition and to produce a signal usable to disable the high energy laser source.

2. An optical laser burn through sensor as defined in claim 1, and further comprising:
a light diffuser, positioned near the optical detector to reduce the need for alignment of the optical detector with laser light from the high energy source; and
an optical filter, positioned to receive light entering the optical detector, to ensure that only light from the high energy laser source affects the optical detector.

3. An optical laser burn through sensor as defined in claim 1, wherein the circuitry coupled to the optical detector comprises:
an amplifier, to amplify output from the optical detector;
a comparator, to compare the output from the optical detector with a selected threshold level; and
a latch to retain an alarm condition when the output from the optical detector exceeds the threshold level.

4. An optical laser burn through sensor as defined in claim 3, wherein the circuitry coupled to the optical detector further comprises:
an alarm indicator coupled to the latch to provide an indication of an alarm condition.

5. An optical laser burn through sensor as defined in claim 4, wherein the alarm indicator comprises a photodiode.

6. An optical laser burn through sensor as defined in claim 4, wherein the circuitry coupled to the optical detector further comprises:
means for disabling operation of the high energy laser source.

7. An optical laser burn through sensor as defined in claim 6, wherein the means for disabling operation of the high energy laser source comprises a relay.

8. An optical laser burn through sensor as defined in claim 3, wherein the circuitry coupled to the optical detector further comprises an adjustable reference signal supplying the threshold level.

9. An optical laser burn through sensor as defined in claim 1, and further comprising:
a thermal detector located to sense any increase in temperature adjacent to the optical detector; and
circuitry coupled to the thermal detector, to produce a backup alarm indication of a burn through condition and to produce a secondary signal usable to disable the high energy laser source.

10. An optical laser burn through sensor as defined in claim 9, and further comprising:
means for logically combining the signal generated by the circuitry coupled to the optical detector and the secondary signal generated by the circuitry coupled to the thermal detector, to produce a composite signal for disabling the high energy laser source.

11. An optical laser burn through sensor as defined in claim 10, wherein the means for logically combining comprises a logical OR circuit that produces the composite signal when either the optical detector or the thermal detector senses laser burn through.

12. Apparatus for sensing laser burn through in any of a plurality of optical components receiving energy from a high energy laser source, the apparatus comprising:
a plurality of optical laser burn though sensors, each comprising an optical detector located to receive laser light whenever laser burn through occurs, and circuitry coupled to the optical detector, to produce an alarm indication of a burn through condition; and
means for logically combining the alarm indications of a burn through condition, to provide a high energy laser disabling signal whenever at least one of the plurality of optical laser burn through sensors produces an alarm indication

13. Apparatus as defined in claim 12, wherein each laser burn through sensor further comprises:
a light diffuser, positioned near the optical detector to reduce the need for alignment of the optical detector with laser light from the high energy source; and
an optical filter, positioned to receive light entering the optical detector, to ensure that only light from the high energy laser source affects the optical detector.

14. Apparatus as defined in claim 12, wherein the circuitry coupled to the optical detector in each laser burn through sensor comprises:
an amplifier, to amplify output from the optical detector;
a comparator, to compare the output from the optical detector with a selected threshold level; and
a latch to retain an alarm condition when the output from the optical detector exceeds the threshold level.

15. Apparatus as defined in claim 13, wherein the circuitry coupled to each optical detector further comprises:
an alarm indicator coupled to the latch to provide an indication of an alarm condition.
